(19) United States
(12) Patent Application Publication
(10) Pub. No.: US 2018/0131102 A1
(43) Pub. Date: May 10, 2018

(54) Beam squint remediation apparatus in a broadband phased-array antenna system

(71) Applicant: James June-Ming Wang, Pasadena, CA (US)

(72) Inventor: James June-Ming Wang, Pasadena, CA (US)

(21) Appl. No.: 15/460,237

(22) Filed: Mar. 16, 2017

Related U.S. Application Data
(60) Provisional application No. 62/419,946, filed on Nov. 9, 2016.

(51) Int. Cl. H01Q 21/22; H01Q 3/38

(52) U.S. Cl. CPC H01Q 21/22; H01Q 3/38

(57) ABSTRACT

A hierarchical phase shift and delay apparatus enables a large broadband phased-array antenna that is not subject to beam squint. The size of the phased-array antenna both in physical dimension and in number of array elements determines the number of hierarchical delay levels. A method for squint compensation distributes control signal values for phase shift, gain, and time delay for each block. Embodiments of digital squint compensation include phase shift indexers, a plurality of switches coupled to ground taps of a floating strip to adjust the characteristic impedance of a transmission line for fine adjustment; and a hierarchy of tunable squint compensation structures including die-level squint compensation structures coupled to each of the radio frequency chains; and panel-level true time-delay phase shift structures coupled to each of the die-level squint compensation structures. The article of manufacture enables aggregation of sub-arrays which are fabricated to avoid beam squint.

### CROSS-REFERENCES TO RELATED APPLICATIONS

This non-provisional application benefits from the Nov. 9, 2016 priority date of provisional application 62419946, entitled True Time-Delay Phase Shifter.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

Phased-array antenna systems have a wide range of applications for example in radar, imaging, and satellite communication systems. In particular, radio frequency solid-state circuits provide beam forming and dynamic pointing at orbiting stations for mobile handsets.

### BACKGROUND

Modern active radio antennas use phased-array technology for beam steering. As is known, a planar phased-array antenna consists of a number of antenna elements. Incoming planar waveforms arrive at different antenna elements of a receive phased-array antenna at different delays. These delays are conventionally compensated with phase shifts before the signals are combined. Conversely, a transmit array consists of a number of antenna elements, and the signals for these elements are phase shifted before they are transmitted to adjust for signal delay toward a desired direction. Phase shifter is a simplified implementation which compensates delay from zero up to one carrier frequency cycle, Δ, with modulo one frequency cycle operation. The phase-shifted signals from different antenna elements, still containing integer multiples of frequency cycle delays, nΔ, are combined into one signal. The combined signal quality suffers from frequency dispersion. The frequency dispersion is generally acceptable in a narrow band signal. Combined Signal=Σₖ₌₀^{l-1}S(t−nₖΔ)

A beam squint effect occurs when the geometry of a phased-array substantially diverges from the wavelength of desired signals. As is known, a conventional phased-array antenna with elements spaced by constant distance d exhibits a change in beam direction (Theta) as a function of change in frequency (or wavelength). This can be experienced as a loss of gain in the intended direction. A broadband signal requires diversity across a range of frequencies. As is known, for a narrow band signal, a phase shifter can provide signal delay from zero up to one cycle of the signal carrier frequency. But for a broadband signal the lower frequency part of signal content and the higher frequency part of signal content beamform into separate directions causing loss. This is generally referred to as beam squint. Ideally, a large wideband phased-array antenna system having a large number of antenna elements provides a narrow beamwidth. Beam squint causes undesirable loss. In addition, frequency dispersion affects the quality of a received broadband signal significantly as signal content is spread out over a wide bandwidth. Thus, the frequency content deviated from the center suffers power loss due to beam off-pointing and also time delay due to phase shifter after being combined.

Conventional delay and phase shifting are uneconomical for large scale phased arrays. There are great difficulties in implementing difference delay compensation to align the phase of two elements, specifically, for a large phased array antenna operating at high frequency. First the separation between antenna elements can be large. To produce a large delay to the signal of an element, a large structure of propagation medium for signal (wave) is needed. It is desirable to use a propagation medium with a slow speed of wave propagation. The speed of wave in a medium is inversely proportional to the square root of the product of permittivity and permeability. In general, commonly available low loss microwave propagation medium can only have limited speed of wave propagation and the signal needs to be amplified after the delay compensation.

To avoid loss, total difference delay compensation experienced between any two elements should be =distance between the center of the two elements*COS(Theta)/C. Ideally, this could align the phase of two elements. A simpler implementation is to employ phase shift instead of delay compensation. A phase shifter provides a signal delay compensation from zero up to one cycle of the signal carrier frequency. Delay compensation with a phase shifter beyond one cycle of the signal carrier frequency is truncated by an integer number of cycles. For narrow band signals, phase shifter and delay compensation are equivalent. For a wideband signal, phase shifter compensation produces signal dispersion and additionally the beam direction of the signal content at different portions of signal frequency deviates from each other.

A phased-array antenna for a wideband signal implemented with difference delay compensation (instead of phase shifter) eliminates the beam squint issue but incurs very high degree of implementation complexity. For a high frequency phased-array antenna for a wideband signal with difference delay compensation, the implementation complexity becomes prohibitive since antenna elements need to be placed within less than a wavelength and the space available for difference delay compensation is very limited.

As is known, it is necessary to align the phase of any two elements in a large phased-array antenna operating at high frequency. As is known, a large structure of propagation medium is conventionally needed to produce a large delay. Using a propagation medium with slow speed of wave propagation would be desirable. Adding to the implementation complexity, antenna elements need to be physically placed within less than a wavelength so the space available for wave propagation delay is very limited.

For large phased-array antenna systems, operating over a broadband signal, the necessary phase shift may exceed the range of individual radio frequency (rf) chains in the beam forming circuits. What is needed is an improved way to arrange adjustable phase shifters or difference delay compensation to avoid squint for very large arrays.

The invention presents a remediation to beam squint for planar broadband signal antenna systems. What is needed is an apparatus for a large scale directional antenna that supports a broadband signal. Because there are multiple wavelengths supported in this broadband signal application, there is potentially loss due to beam squint. Because it is a large scale directional antenna, there will be many sub-arrays of phased array antenna elements. At the extreme angles of beam direction, there will be substantial distance between the sub-arrays at one edge and the sub-arrays at the opposite edge. As a result of this separation, the apparatus needs to transform signals emitted or received by antenna elements positioned many wavelengths apart into one coherent signal with no signal loss and no frequency dispersion. A planar phased-array antenna system is sought to address these requirements: broadband signal, compact presentation of antenna elements, substantial separation of antenna elements on opposite edges of the periphery of the array, and low cost of materials and manufacture. What is needed is an article of manufacture that enables assembly of a large broadband phased-array antenna which remediates or avoids beam squint.

### SUMMARY OF THE INVENTION

Broadband signal phased-array antenna system includes a hierarchy of time delay/phase shift of signal waveforms.

A hierarchy of signal transformation enables a large scale broadband phased-array antenna system to compensate for beam squint, incoherence, and dispersion. A plurality of panels include sub-arrays and distributed flighttime delay assemblies. Within each panel are groups of sub-arrays coupled to variable gain amplifiers and variable difference delay compensation structures which in combination provide beam squint compensation to the signals. A transformation by time delay, phase shifting, and variable gain coupled to each antenna element of a sub-array causes a directed beam.

The size of the phased-array antenna both in physical dimension and in number of array elements, the signal bandwidth, and maximum scanning direction determine the hierarchical delay levels.

To align the phase of any two subsystems, the total difference delay compensation should be =distance between the center of the two subsystems*COS(theta)/C, where theta is the scanning direction.

First level of hierarchical time delay addresses flighttime across panels that make up a large antenna of phased-array elements.

The potential squint effects among panels are compensated with difference delay compensation with greater implementation complexity (larger maximum delay compensation). But the number of such higher complexity difference delay compensation are reduced significantly.

Second level of hierarchical time delay enables separation of squint remediated blocks of sub-arrays within each panel.

Multiple sub-arrays in proximity form a second level block with variable difference delay compensation between blocks. The beamforming direction of the second level may be achieved by setting phase shifters in all the sub-arrays within each second level block to the same beamforming direction and/or setting the variable difference delay compensation values in the second level for that beamforming direction. Note that the maximum difference delay compensation is determined by the span of the second tier block.

Third level of hierarchical time delay is the variable phase shift and gain that enables beam steering by each sub-array of antenna elements.

The hierarchical phase shifter and true-time delay apparatus contains a number of sub-arrays, each sub-array consists of a number of antenna elements in proximity which may be phase compensated by coupling to low complexity adjustable phase shifters. The beamforming direction of the sub-array can be determined by the phase shifter setting. The size of the sub-array is determined by the bandwidth of the signal and maximum scanning angle from boresight to avoid beam squint. The mid-points (phase center) of each sub-array is pertinent to the calculation of delay required at the second level of hierarchy.

Broadband beam squint effect is substantially remediated by combining a hierarchical delay structure with sub-arrays tuned to suppress the effect.

With this novel arrangement, if the number of antenna elements within the phased-array antenna is k, k number of low complexity variable phase shifters are required. If the number of antenna elements within the first tier sub-array is l, the number of the second tier variable difference delay compensation is k/l. This reduces the implementation complexity significantly.

The phased-array antenna contains multiple tiers of sub-arrays, with the antenna elements in the first tier sub-array compensated with low complexity phase shifters. The second or higher tier (third tier or higher) of sub-arrays are compensated with difference delay compensation with increasing implementation complexity (larger maximum delay compensation). But the number of higher complexity difference delay compensation are reduced significantly.

### BRIEF DESCRIPTION OF FIGURES

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B illustrate a plurality of panels of antenna elements which combine to make up a phased array antenna system and the problem and solution presented in the present invention;

FIGS. 2A and 2B illustrate a plurality of sub-arrays of a phased-array antenna system and the beneficial effect of a squint compensator of the present invention;

FIGS. 3A and 3B illustrate antenna elements of a sub-array dimensioned to minimize beam squint in broadband operation and the effect of beam forming by phase and gain control;

FIG. 4 is a side view illustration of relative geometrical relationships within a true time-delay structure;

FIG. 5A is a side view of a slow wave structure. FIG. 5B is a top view of the slow wave structure with additional switches; and

FIG. 6 shows a plurality of slow wave structures that are switchable into and out of series to provide a wide range of true-time delays.

### DETAILED DISCLOSURE OF EMBODIMENTS

A broadband signal phased-array antenna is an article of manufacture having an obverse surface in which is embedded a pattern of antenna elements, and coupled to the antenna elements by signal leads, switches, and electrostatic discharge protection, a plurality of beam control die mounted to the reverse surface of the article. A panel-level switchable time-delay phase shift structure device is coupled to each of the beam control die. Each beam control die has inputs and circuits for phase shifting, adjustable gain, and a die-level selectable squint compensation, e.g. a time-delay phase shift structure.

The angle of incidence of the beam, operating wavelength, and separation of antenna elements determines the desired true-time delay to compensate for beam squint.

A transmission line with digitally controlled characteristic impedance is embedded in a hierarchy of beam control dice mounted on a large broadband phased-array antenna.

In practice, it is difficult to implement a slow wave propagation speed using high permittivity or permeability material. The low loss material for high frequency implementation generally has limited permittivity and permeability. The first preferred implementation of the difference delay compensation is to employ slow wave structure which employs novel transmission line structure realized in the conventional low loss microwave material with moderate permittivity and permeability to further lower the speed of the wave propagation. This allows wave propagation to be 4 to 5 times slower than free space, thus, allows for compaction in implementation. In addition, a planar implementation which can meander signal propagation path allows for further space compaction in implementation. To overcome signal loss in the difference delay compensation, variable amplifier gain are used to compensate for signal loss. Several embodiments of digitally adjustable time-delay articles of manufacture for broadband signal transformation in a solid state die include a fine adjustment signal transmission line with signal trace and a plurality of floating metal strip orthogonal to the signal trace. The plurality of floating metal strip connect to a plurality of switches coupled to taps of the floating metal strip for adjusting the characteristic impedance of a transmission line. The switch changes the electric field (capacitance) and magnetic field (inductance) between signal trace and ground, thus, changing the effective signal propagation speed for fine adjustment. By switching on a number of the switches and switching off the remaining number of switches, different propagation delay can be achieved. Note that the characteristic impedance and propagation speed of a transmission line is

Characteristics Impedance Z₀=\sqrt{L/C} and

Propagation velocity=1/(c*\sqrt{L*C})

where L is the distributed inductance (in henries per unit length), C is the capacitance between the two conductors (in farads per unit length), and c is the speed of light in vacuum. Applicant suggests an embodiment of transmission line for delay line to maintain the same ratio of inductance and capacitance when the switch is in either the off state or on state to maintain the impedance match of the transmission line in either of both states. Thus, the same characteristic impedance but different propagation velocities are achieved in two states. This means that when the switch is open, a large inductance and a large capacitance are obtained, corresponding to a slow speed and when the switch is closed, a small inductance and a small capacitance are obtained, corresponding to a fast speed. Various electro-magnetic structure can satisfy the proposed property for realizing such fine adjustment delay transmission line.

An alternate embodiment, employing fixed slow wave structure, i.e., no switchable floating metal strip employed, is to have both long and short fixed slow wave true time delay transmission lines and to select among them for large adjustment. Since it is easier to implement the fixed slow wave true time delay, this can typically be used for implementing larger delay compensation. Another preferred embodiment is to employ sampled tap-delay structure, in which signal is sampled by a clock, and signal propagation through a number of sampled and hold circuit. The output is selected from one of the taps. The adjustable delay is an integer number of sampling clock cycles.

A hierarchy of time-delay structures comprising a plurality of die-level true time-delay structures coupled to each of the plurality of radio frequency (rf) chains; and a panel-level true time-delay structure coupled to each of the plurality of die-level time-delay structures, whereby a panel-level control value compensates for squint across a plurality of antenna element sub-arrays and each die-level control value compensates for squint across antenna elements coupled to each die. For squint compensation within specific limited operating bands, a variable true-time delay vernier structure is programmed into each die of an array at assembly according to its position in the array. For unlimited bandwidth squint compensation, true time-delay phase shift is determined and distributed to each block of antenna elements.

Several time-delay phase shift structures are disclosed including at least one variable true-time delay circuit including: a band pass filter coupled to an output and selectably coupled to at least one output of a plurality of sample and hold amplifiers; said plurality of sample and hold amplifiers coupled in series to an input whereby each subsequent output is one clock delay removed from said input; a clock coupled to all said sample and hold amplifiers; and a control to select the number of clock cycles by which the output is delayed from the input.

An exemplary time-delay phase shift structure is a complex impedance transmission line superposed over a dielectric composition within which is at least one floating conductive strip.

Another exemplary time-delay phase shift structure is a complex impedance transmission line superposed over a dielectric composition within which is a conductive strip having multiple ground taps controlled by a plurality of switches. The signal path length within the transmission line is always constant from input to output. However the delay is affected by the position and number of ground taps coupled to the substrate by the plurality of switches. A delay value decoder provides digital logic control over the operation of the switches.

Each beam control die on an addressable bus receives a packet containing selectable time-delay, phase shift, and adjustable gain.

Additionally, each group of die is coupled to a switchable true-time delay component in hierarchical manner.

The present invention includes a hierarchy of time-delay structure feeding signals to arrays of signal gain and phase shifters driving a plurality of separate antenna element structures in transmission. In reception, the beam direction is controlled by the variable gain and phase, and beam squint is compensated by the hierarchy of time-delay structures.

A control circuit loads gain and phase settings for each antenna element and a phase shift or time delay to compensate for beam squint. In combination, the antenna elements drive a beam direction and optimize antenna gain at various wavelengths.

A frequency diverse phased-array antenna is fabricated by printed circuit board techniques to operate across multiple broadband standards. The angle of beam incidence, the wavelength, and the beam direction will change substantially more often within a few minutes of 5G communication sessions. Thus, more rapid squint compensation is necessary for economical power and area budgeting. In an embodiment for a large broadband phased-array antenna operating in the frequency range of 27.5-32.5 GHz, the apparatus provides means for determining a delay substantially equal to 2.828 cm*COS (theta)/C wherein theta is the desired beam direction and C is the speed of light. The means for determining the delay is one of an electronic circuit and a processor performing instructions encoded in firmware read from non-transitory computer readable media.

True time-delay phase shifters and other squint compensation is a part of large broadband phased-array antennas. In addition to the adjustable phase and gain requirements for steering beam orientation in a phased-array of antenna elements, time-delay phase shifting is used to compensate for squint when broadband wavelengths are supported by a large array of antenna elements.

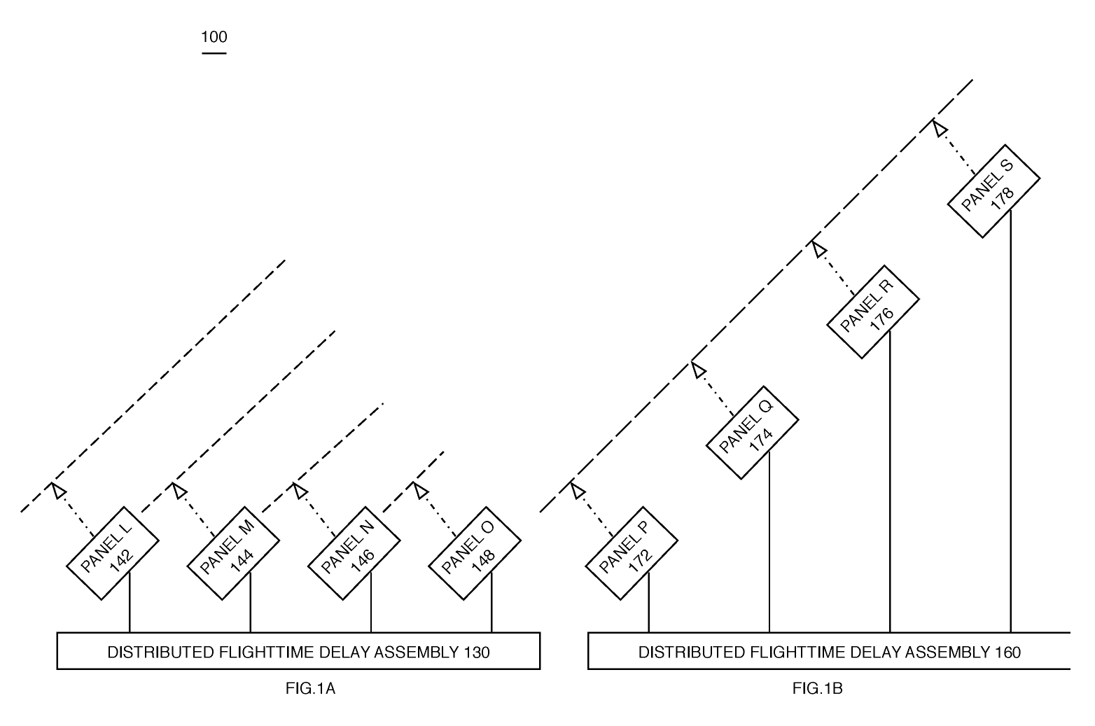

Referring to FIG. 1A, a plurality of phased-array antenna panels are spread across an antenna system. When signal incidence substantially diverges from vertical, each panel may direct its beam appropriately, but a ripple effect of emission or reception may introduce incoherence because the time of flight to Panel L 142 is shorter than to Panels M, N, and O 144-148. If a distributed flight time delay assembly 130 were correctly configured, panel emissions could be synchronized rather than rippled. Ideally, the panels would be virtually elevated to the same plane with respect to signal incidence as illustrated in FIG. 1B. This is the desired beneficial effect provided by distributed flighttime delay assembly 160 coupled to Panels P, Q, R, and S 172-178.

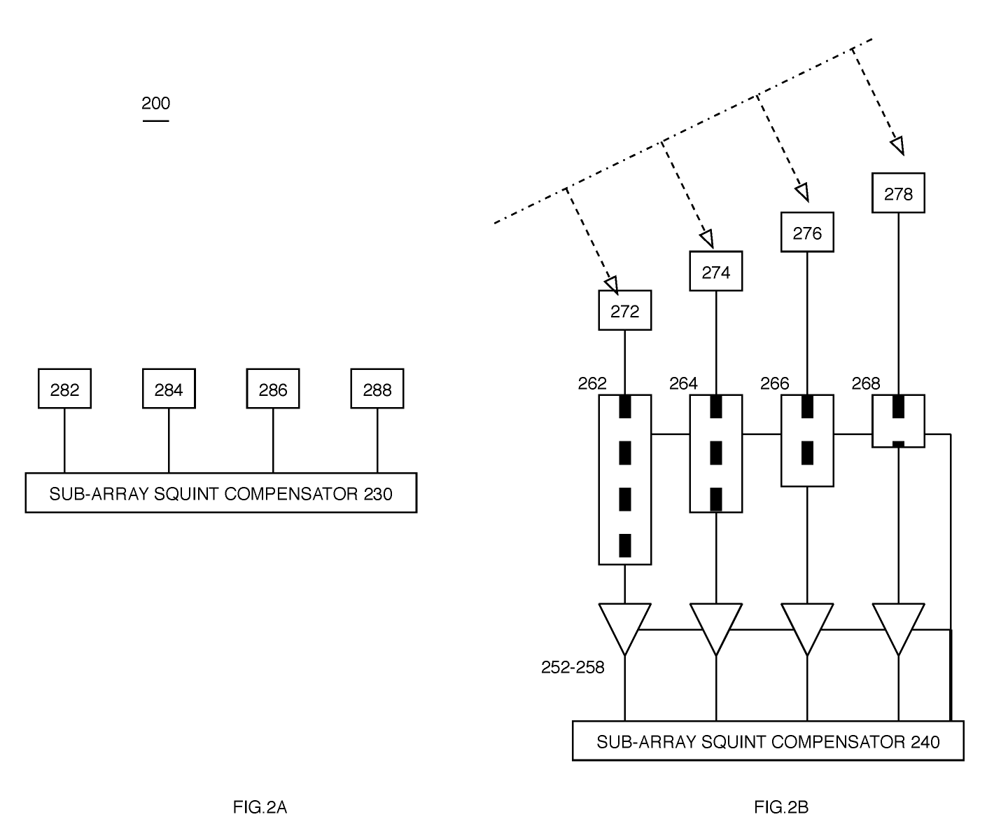

Referring to FIG. 2A, integrated within each of the phase-array panels of FIG. 1A and FIG. 1B are a plurality of sub-arrays 282-288 coupled to a sub-array squint compensator 230. Beam squint for each sub-array may be minimized by design of each sub-array. However, the degree of phase shift between sub-arrays can exceed the range of the phase shifters within the sub-array. As shown in FIG. 2B, groups of antenna elements in sub-arrays 272-278 are each coupled to variable difference delay structures 262-268 controlled by the sub-array squint compensator 240. Adjustable gain amplifiers 252-258 recover the signal loss incurred by variable difference delay structures. A controller of the sub-array squint compensator 242 sets the gains and difference delays determined for each angle of incidence. The quantity of delay required among adjacent sub-arrays is much less than the amount necessary between panels that span the antenna system.

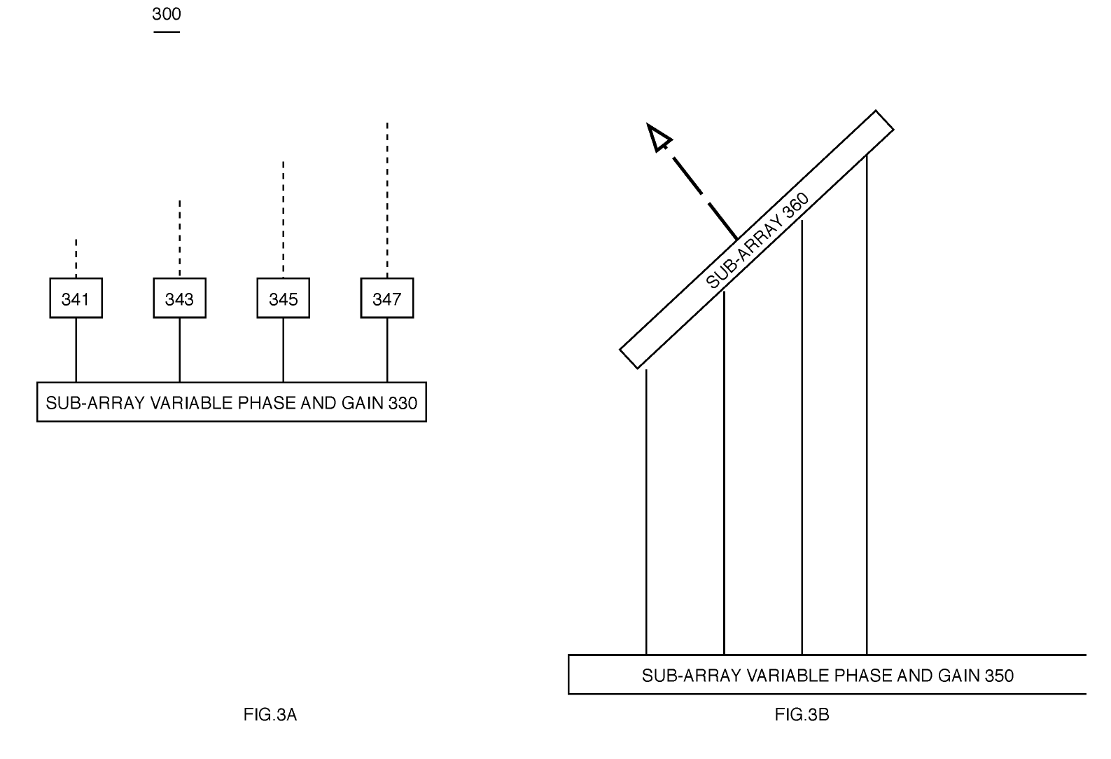

Referring to FIG. 3A, each antenna element of a sub-array 341-347 is coupled to a variable phase and gain chain 330. The electromagnetic field effect of operating these elements (separated by a certain distance) is a directed beam as if as shown in FIG. 3B the sub-array is tilted to provide a beam direction. Although each sub-array receives the same phase and amplitude input for beam direction, the signals themselves are transformed by the variable difference delay structures of FIG. 2B to remediate the effect of beam squint.

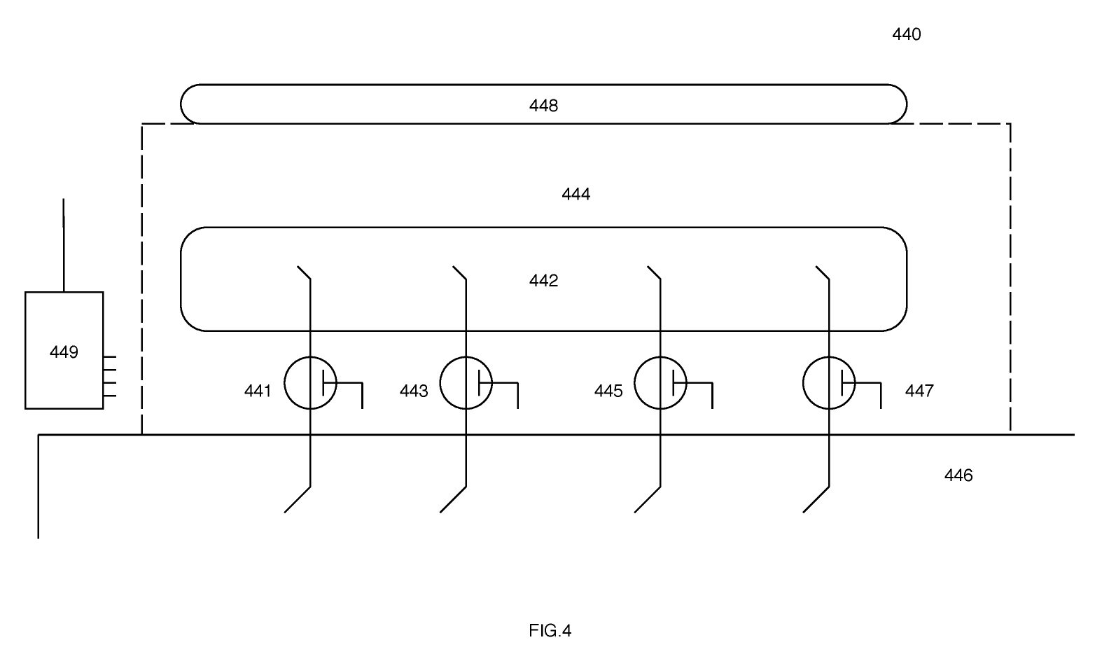

As shown in FIG. 4 each panel-level phase delay component is a switchable true time-delay phase shifter structure 440. In embodiments, a die-level phase delay structure is a variable true time-delay phase shifter structure.

A variable true-time delay phase shifter structure is a transmission line with selectable characteristic impedance. A floating strip of conductive material 442 is manufactured within a dielectric composition 444 above a substrate 446. A signal conductive lead 448 is deposited on the upper strata of the dielectric composition. A plurality of switches 441, 443, 445, 447 couple the substrate to selectable taps on the floating strip. A control value decoder 449 coupled to the switches determines the characteristic impedance of the transmission line and transforms the signal with true time-delay.

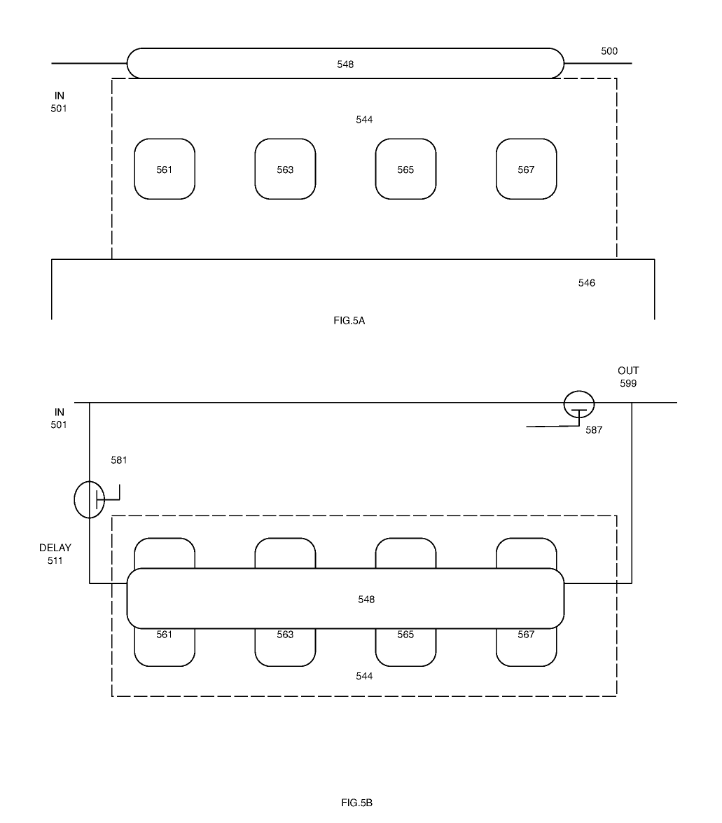

FIG. 5A is a side view of a single slow wave time delay structure in an article of manufacture. FIG. 5B is a top view of a single slow wave time delay structure in an article of manufacture. In FIG. 5A a substrate 546 supports a dielectric composition 544 within which are a plurality of parallel conductive bars 561-567. Deposited onto the dielectric composition is a signal carrying lead 548 which crosses above all the conductive bars attached to an input port 501. The signal carrying lead is in a plane parallel to the plane of the conductive bars but is oriented perpendicular to each of the conductive bars. In FIG. 5B the top view of the dielectric composition 544 and the conductive bars 561-567 is shown again as if the dielectric composition was transparent. An output port 599 is also shown coupled to a selectable switch 587 and to 548. A selectable switch is coupled between the input port 501 and 548. These switches connect to the signal carrying lead 548 and when operated in opposition cause the slow wave structure to be in series or short circuited. This slow wave true time delay structure is provided for synchronization across multiple panels of a large broadband phased-array antenna (e.g. above 64 elements at 2 GHz bandwidth)

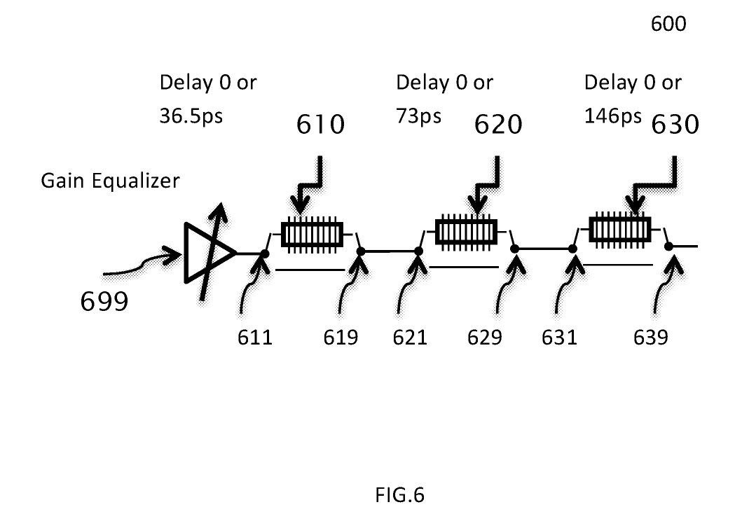

FIG. 6 shows switchable true-time delay structure 600 including a plurality of slow wave structures such as but not limited to 500 that are individually switchable into or out of series to provide a wide range of true-time delays. A plurality of switch pairs 611-619, 621-629, 631-639 place selected slow wave structures into or out of series. Exemplary values are shown for the slow wave structure delays controlled by the switches: 610 zero or 36.5 ps, 620 zero or 73 ps, 630 zero or 146 ps. A gain equalizer 699 adjusts for the losses incurred by passing a signal through the whichever number of switchable slow wave structures are selected.

One aspect of the invention is a method for operation of squint compensation of a broadband phased-array antenna signal transformation apparatus including: determining an angle of incidence for a signal beam to each antenna element of a broadband phased-array antenna; determining a phase, gain, and time delay for each antenna element of a broadband phased-array antenna at a selected wavelength; and transmitting control signal values to a signal transformation apparatus for phase shift, gain, and time delay for each antenna element.

In an embodiment determining time delay includes: determining time delay by receiving selected scanning angle, and computing a time delay for each element of the phased-array by (4*d*Sqrt(2)*COS(θ))/C, where θ is the scanning angle, C is the speed of light, and d is substantially one-half of a selected wavelength of an operating frequency band.

The total difference delay compensation between any two elements is determined =distance between the center of the two elements*COS(theta)/C where C is speed of light.

This aligns the phase of two elements.

As an example, the total delay experienced by each element is sum of the following (three layer implementation: first layer 4×4 elements, second layer 2×2 sub-arrays, third layer groups of sub-arrays).

For elements within a (e.g. 4×4 square) sub-array align to the center of the sub-array. This is done in phase shifters within the 16 RF chains in a die.

For a small area consisting of 2×2 sub-arrays, they can align to the center point in the middle. Squint compensation is added by the variable true-time delay structure at the output of each die.

For the whole panel, a plurality of switchable true-time delay structures compensate for the delay between the center of the sub-arrays.

Another aspect of the invention is a digitally tunable time-delay phase shift article of manufacture for broadband signal transformation in a solid state die including: a semiconductor substrate (substrate); a dielectric composition above the substrate; a floating strip of metal (strip) embedded within the dielectric composition; at least one switch coupled to the substrate and to the strip; a signal conduction lead above the dielectric composition coupled to a broadband input port and to a broadband output port; and a multi-bit time delay control value decoder coupled to the at least one switch and coupled to a digital time delay control port.

A more rigorous definition of slow wave structure can be described as follows:

A wave propagation medium is constructed with sub-wavelength periodic (typically metal) structure in a dielectric substrate.

As is known, a magnitude of wave within the medium follows a periodic function with the same periodicity as the structure (per Bloch Theory, aggregation of Schoedinger equation).

Advantageously, the invention benefits from wave scattering directions and phase varies within periodic structure but in a periodic fashion, which thus slows down the wave.

In an embodiment, each wave interacts with metal (tangential component=0 at metal surface) and dielectric (causing polarization within the substrate) and, as a result, the effective dielectric constant (and characteristic impedance) is variably controllable due to the periodic structure, resulting in the shorter wavelength beneficially reducing implementation size.

A non-limiting exemplary embodiment uses a very small floating metal strip, which blocks the EM fields into the substrate (reducing polarization effects in the substrate) and reduces eddy current (small strip). Thus, the transmission loss is reduced.

Another aspect of the invention is a broadband phased-array antenna including: a plurality of antenna elements embedded in a block of substrate; each antenna element coupled to, a radio frequency (rf) chain comprising a phase shifter and an adjustable gain amplifier; an antenna polarization switch; an input port for incremental time-delay per block of substrate; and electrostatic discharge protection.

In an embodiment, a broadband phased-array antenna also includes: an input port for transmit signal; an input port for phase value; and an input port for adjustable gain value.

In an embodiment, a broadband phased-array antenna also includes: an output port for receive signal; an input port for phase value; and an input port for adjustable gain value.

Another aspect of the invention is signal transformation apparatus including: at least one variable time-delay phase shift structure; a radio frequency (rf) chain comprising a phase shifter and an adjustable gain amplifier; an input port for incremental time-delay per block of substrate; an input port for phase value; and an input port for adjustable gain value.

In an embodiment, a tunable time-delay phase shift structure includes: a signal conductance lead having a plurality of signal taps at increments of time delay; a controllable switch to select one of the plurality of signal taps corresponding to a desired aggregation of time delay applied to the signal; and a controllable gain circuit coupled to the switch to normalize the amplitude loss of the signal transiting the time-delay structure.

Another aspect of the invention is a switchable time-delay phase shift structure including: a complex impedance signal transmission line having a plurality of floating strips interposed between a signal conductance lead and a substrate; and a pair of controllable switches on the signal conductance lead corresponding to a desired aggregation of time delay applied to the signal.

In an embodiment, the switchable time-delay phase shift structure also has a controllable gain circuit coupled to the switch to normalize the amplitude loss of the signal transiting the time-delay structure.

In an embodiment, a variable time-delay phase shift structure includes a complex impedance transmission line.

In an embodiment, a complex impedance transmission line includes a floating strip of metal (strip) interposed between an analog signal conductance lead and a substrate; and a plurality of switches coupled to ground taps of the strip to adjust the impedance of the transmission line.

In an embodiment, a control value decoder is selectively coupled to at least one of the ground taps of the strip to the substrate corresponding to a desired time delay applied to an analog signal.

In an embodiment, the broadband phased-array antenna includes a hierarchy of die-level and panel level true-time delay structures.

In an embodiment, a hierarchy of true-time delay structures includes a plurality of die-level time-delay structures coupled to radio frequency (rf) chains; and a panel-level time-delay structure coupled to each of the plurality of die-level time-delay structures.

In an embodiment, a panel-level control value compensates for squint across a plurality of antenna element sub-arrays. In an embodiment, each die-level control value compensates for squint across antenna elements coupled to each die.

In an embodiment, at least one first time delay control circuit is coupled to at least one die-level time-delay structure. In an embodiment at least one second delay control circuit is coupled to a panel-level time-delay structure.

The following hierarchical true-time delay structure is disclosed. For each 4×4 antenna element a phased-array processing die is used to form a sub-array. The 4 of the sub-arrays formed in 2×2 configuration. The first level of adjustable true-time delay element is embedded within the phased-array processing die which compensates the time delay of the 2×2 sub-array configuration (containing 64 antenna elements).

The true time delay needed for a 4×4 element square array is calculated as follows: The maximum true-time delay is (4*d*Sqrt(2)*COS(θ))/C, where θ is the maximum scanning angle, C is the speed of light, and d is the element spacing. For element spacing at λ/2 at a frequency of 27.5 GHz and maximum scanning angle of 45 degree, the required true time delay is (0, 146) pico-second. To compensate for 2×2 sub-array configuration, the Variable True-Time Delay Macro within the phased-array processing die provides the compensation in the range of (0, 2×146) pico-second.

To form a 256 element array in a 16∴16 configuration, 4 standalone switchable True-Time Delay dies are needed, each provides compensation in the range of (0, 4*146) pico-second. Note that each switchable true-time delay also contains gain equalizer to compensate for the signal attenuation through the time delay. A bigger array will require a larger switchable true-time delay module (or several).

To implement a switchable true-time delay Macro or die, multiple sections of the slow wave transmission line are needed. The minimum resolution should be less than a 360 phase shifter. For further adjustment, the phase shifter in the TX or RX phased-array processing die can be adjusted by a common phase.

### Conclusion

Advantageously, true-time delay structures are easily integrated into semiconductor devices and thus scale in volume manufacture of large phased-array antennas. The present invention includes a hierarchy of time-delay structures feeding signals to arrays of signal gain and phase shifters driving a plurality of separate antenna element structures in transmission. In reception, the beam direction is controlled by the variable gain and phase, and beam squint is compensated by the hierarchy of true-time delay structures. The invention can be easily distinguished from cascading different numbers of identical delay cells such as RC or LC circuits which would result in poor utilization of semiconductor area and fabrication cost. That is, fabricating the number of delay cells necessary for the extreme range of delays would result in poor utilization of the area for most common i.e. most likely requirements. Advantageously, a tunable transmission line utilizes a fixed area at all frequencies to provide the range of desired characteristic impedances.

A control circuit loads gain and phase settings for each antenna element and a phase shift or time delay to compensate for beam squint. In combination, the antenna elements drive a beam direction and optimize antenna gain at various wavelengths.

A number of embodiments of the invention have been described. Nevertheless, it will be understood that various modifications may be made without departing from the spirit and scope of the invention. Accordingly, other embodiments are within the scope of the following claims.

1. A broadband phased-array antenna system comprising:
a distributed flighttime delay assembly; communicatively coupled to,
at least one sub-array beam squint compensator; each squint compensator coupled to, a plurality of sub-arrays of phased-array antenna elements, whereby
signals emitted by said plurality of sub-arrays are transformed by delay and phase shifting to form directed beams, whereby broadband beam squint is minimized, and whereby signals across the antenna system are emitted in coherent order.

2. The broadband phased-array antenna system of claim 1 wherein the distributed flighttime delay assembly comprises:
a meandering signal path through a medium providing propagation delay; coupled by
a plurality of switches; coupled to
a plurality of slow wave complex impedance transmission lines; and
a switch controller which determines desired flight time delay from beam direction, and configures transmission lines and signal path in series to coherently combine signals from all phased-array elements across the antenna system.

3. The broadband phased-array antenna system of claim 1 wherein the at least one sub-array beam squint compensator comprises:
at least one variable gain amplifier coupled to a sub-array;
at least one variable difference delay structure coupled to said variable gain amplifier; and
a controller to set variable gain and variable difference delay to transform signals for each group of sub-arrays.

4. The broadband phased-array antenna system of claim 3 wherein each sub-array is sized to be substantially immune to broadband beam squint.

5. The broadband phased-array antenna system of claim 1 wherein the sub-array of phased-array antenna elements further comprises:
a variable gain amplifier coupled to each antenna element;
a variable phase shifter coupled to each variable gain amplifier; and
ports to receive antenna weights for variable gain, phase, and radio frequency signals, whereby radio frequency signals are transformed into a directed beam.

6. The broadband phased-array antenna system of claim 3 wherein said variable difference delay structure comprises:
a complex impedance transmission line having a floating strip of metal (strip) interposed between an analog signal conductance lead and a substrate;
a plurality of switches coupled to ground taps of the strip to adjust the impedance of the transmission line;
a control value decoder to selectively couple at least one of the taps of the metal strip to the substrate corresponding to a desired aggregation of time delay applied to an analog signal; and
a controllable gain circuit coupled to the transmission line to normalize the amplitude loss of the signal transiting the time-delay structure.

7. The broadband phased-array antenna system of claim 2 wherein each slow wave complex impedance transmission line comprises:
a substrate; which supports
a dielectric composition; within which are
a plurality of parallel conductive bars; deposited onto the dielectric composition is
a signal carrying lead (lead) which crosses above all the conductive bars, the lead attached to an input port; wherein the signal carrying lead is in a plane parallel to the plane of the conductive bars but is oriented perpendicular to each of the conductive bars; and
switches coupled to the signal carrying lead and when operated in opposition cause the slow wave structure to be one of in-series and short-circuited.

8. A digitally tunable time-delay phase shift article of manufacture for broadband signal transformation in a solid state die comprising:
a semiconductor substrate (substrate);
a dielectric composition above the substrate;
a floating strip of metal (strip) embedded within the dielectric composition;
at least one switch coupled to the substrate and to the strip;
a signal propagation conduction lead above the dielectric composition coupled to a broadband input port and to a broadband output port; and
a multi-bit time delay control value decoder coupled to the at least one switch and coupled to a digital time delay control port.

9. A broadband phased-array antenna comprises:
a plurality of panels each comprising,
a plurality of antenna elements embedded in a block of substrate; each antenna element coupled to,
a radio frequency (rf) chain comprising a phase shifter and an adjustable gain amplifier;
an antenna polarization switch; and
an input port for incremental time-delay per block of substrate.

10. The broadband phased-array antenna of claim 9 further comprising:
an input port for selectable flight time delay per panel;
an input port for transmit signal;
an input port for phase value; and
an input port for adjustable gain value.

11. The broadband phased-array antenna of claim 9 further comprising:
an input port for selectable flight time delay per panel;
an output port for receive signal;
an input port for phase value; and
an input port for adjustable gain value.

12. A broadband phased array antenna signal transformation apparatus comprising:
at least one tunable time-delay phase shift structure;
a radio frequency (rf) chain comprising a phase shifter and an adjustable gain amplifier;
an input port for incremental time-delay per block of substrate;
an input port for phase value; and
an input port for adjustable gain value.

13. The apparatus of claim 12 wherein the tunable time-delay phase shift structure comprises:
a signal propagation conductance lead having a plurality of signal taps at increments of time delay;
a controllable switch to select one of the plurality of signal taps corresponding to a desired aggregation of time delay applied to the signal; and
a controllable gain circuit coupled to the switch to normalize the amplitude loss of the signal transiting the time-delay structure.

14. The apparatus of claim 12 wherein the tunable time-delay phase shift structure comprises:
a complex impedance signal transmission line having a plurality of floating strips interposed between a signal conductance lead and a substrate at increments of time delay;
a controllable switch to select one of a plurality of signal taps on the signal conductance lead corresponding to a desired aggregation of time delay applied to the signal; and
a controllable gain circuit coupled to the switch to normalize the amplitude loss of the signal transiting the time-delay structure.

15. The apparatus of claim 12 wherein the tunable time-delay phase shift structure comprises:
a complex impedance transmission line having a floating strip of metal (strip) interposed between an analog signal conductance lead and a substrate;
a plurality of switches coupled to ground taps of the strip to adjust the impedance of the transmission line;
a control value decoder to selectively couple at least one of the ground taps of the strip to the substrate corresponding to a desired aggregation of time delay applied to an analog signal; and
a controllable gain circuit coupled to the transmission line to normalize the amplitude loss of the signal transiting the time-delay structure.

16. The apparatus of claim 12 wherein the tunable time-delay phase shift structure comprises:
a hierarchy of tunable time-delay structures comprising
a plurality of die-level time-delay structures coupled to radio frequency chains; and
a panel-level time-delay structure coupled to each of the plurality of die-level time-delay structures, whereby a panel-level control value compensates for squint across a plurality of antenna element sub-arrays and each die-level control value compensates for squint across antenna elements coupled to each die; and
at least one first time delay control circuit and
a second time delay control circuit, said at least one first time delay control circuit coupled to at least one die-level time-delay structure and said second delay control circuit coupled to the panel-level time-delay structure.

17. A hierarchical true-time delay apparatus comprising:
a plurality of variable true-time delay circuits embedded within each beam steering die coupled to sub-arrays of antenna elements; and,
at least one switchable macro true-time delay line to interface blocks of sub-arrays of antenna elements.

18. The apparatus of claim 17 wherein true-time delay is determined by the angle of incidence of the beam, operating wavelength, and separation of antenna elements.

19. The apparatus of claim 18 for a large broadband phased-array antenna operating in the frequency range of 27.5-32.5 GHz, wherein the apparatus comprises means for determining a delay substantially equal to 2.828 cm*COS (theta)/C wherein theta is the desired beam direction and C is the speed of light.

20. The apparatus of claim 17 wherein at least one variable true-time delay circuit comprises:
a band pass filter coupled to an output and selectably coupled to at least one output of a plurality of sample and hold amplifiers;
said plurality of sample and hold amplifiers coupled in series to an input whereby each subsequent output is one clock delay removed from said input;
a clock coupled to all said sample and hold amplifiers; and
a control to select the number of clock cycles by which the output is delayed from the input.
